(19) United States
(12) Patent Application Publication
(10) Pub. No.: US 2007/0261592 A1
(43) Pub. Date: Nov. 15, 2007

(54) COLLISION ENERGY ABSORBING APPARATUS AND RAILWAY VEHICLE EQUIPPED WITH THE SAME

(76) Inventors: Toshihiko Mochida, Kudamatsu-shi (JP); Takashi Yamaguchi, Hitachinaka-shi (JP); Hideyuki Nakamura, Kudamatsu-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/745,527

(22) Filed: May 8, 2007

(30) Foreign Application Priority Data
May 10, 2006 (JP) 2006-131981
Mar. 14, 2007 (JP) 2007-064585

(51) Int. Cl. B61D 15/06; F16F 7/12

(52) U.S. Cl. 105/392.5; 188/377; 293/133

(57) ABSTRACT

Provided is a collision energy absorbing apparatus capable of mitigating loads to the car body proper, passengers and the like by adding a structure combining a prescribed static strength and collision energy absorption performance to an energy absorbing body of the collision energy absorbing apparatus. In a limited inner space of a car body, a cover 80 that covers energy absorbing bodies 51, 52 combines a prescribed static strength and collision energy absorption performance. The cover 80 prevents irregularities, such as the breakage of cylindrical bodies of aluminum alloy, i.e., the energy absorbing bodies 51, 52 in each of the stages of transportation, storage, assembling and the like of the collision energy absorbing apparatus 50. The cover 80 having static strength fulfills the role of withstanding a prescribed static load and in the event of a collision against an obstacle, the cover 80 is broken earliest and reduces a peak load of crush, with the result that part of the collision energy is used in the breakage of the cover 80. As a result of this, the cover 80 can contribute to the absorption and mitigation of the collision energy.

The present application is based on and claims priorities of Japanese patent application No. 2006-131981 filed on May 10, 2006 and Japanese patent application No. 2007-064585 filed on Mar. 14, 2007, the entire contents of which are hereby incorporated by reference.

### BACKGROUND OF THE INVENTION

1. Field of the Invention

The present invention relates to a collision energy absorbing apparatus that is applied particularly to a railway vehicle, such as a railroad vehicle and a monorailway vehicle, to mitigate an impact during a collision against an obstacle or the like and a railway vehicle equipped with the apparatus.

2. Description of the Related Art

In a railway vehicle represented by a railroad vehicle, there is a possibility that a collision against an unexpected object occurs during a travel. In the case of a railroad vehicle, examples of an unexpected object in past collision accidents include various kinds ranging from large objects, such as a road vehicle, a tree and a railroad vehicle, to small ones, such as a stone, a snow ball, a part of an oncoming vehicle.

A case where a railroad vehicle collides against a large object is considered here. When a collision against a large object occurs, a large impact acts on the railroad vehicle due to this collision against the object. There exists a conception that the collision energy is absorbed by positively deforming part of the structure of the railroad vehicle in order to protect the crew and passengers aboard on the railroad vehicle from this impact. That is, this conception is such that a space in which the structure of the railroad vehicle where the crew and passengers are on board is not crushed upon the collision against the object (this space is hereinafter called “a survival zone”) and a space in which the collision energy is absorbed by positively deforming the structure of the railroad vehicle upon collision against the object (this space is hereinafter called “a crushable zone”) are separately provided.

Next, a case where a railroad vehicle collides against a small object is considered. That is, a stone and a snow ball flung up by an oncoming vehicle through a wind caused by the travel, a part of an oncoming and the like collide against the front of a forefront part of a vehicle. In the case of a collision against a small flying object, the vehicle has an overwhelmingly large mass compared to the flying body and, therefore, a large impact does not act on the vehicle. However, there is a possibility that the flying object may pierce through the vehicle structure, thereby doing damage to a motorman and a passenger on board. Therefore, for a collision against a small flying object, the energy is not absorbed as described above, and there is used a construction which is such that a robust structure is arranged on the vehicle end side of a space where the motorman is on board to prevent the entry of a flying object. A protection plate disposed so that a flying object does not enter a motorman's cab in order to protect the life of the motorman on board is called a flying object protection plate.

The car body of a railroad vehicle is constituted by an underframe, two side structures, a roof structure and two end structures. Center sills and side sills are attached to the underframe and hence the underframe has strong rigidity. Wiring and piping are attached to a lower part of the underframe. Because in the event of a collision, in a railway vehicle, particularly, in a train organized by coupling a plurality of railroad vehicles together, it is necessary to consider a collision between car bodies in the train. The underframe of a railroad vehicle is fabricated to have a robust structure. For this reason, when car bodies in a train collide against each other due to a collision of a vehicle at the head or trail of a train (hereinafter referred to as “a forefront vehicle” including both cases), the underframes collide against each other. Even when the underframes collide against each other, the underframes are not crushed because they are robust, with the result that it is impossible to mitigate the impact.

Therefore, there has been proposed a railroad vehicle which is such that a collision energy absorbing apparatus is provided not only in a forefront vehicle, but also between vehicles of a train. The collision energy absorbing apparatus is an apparatus which absorbs the collision energy by causing buckling to occur, thereby to mitigate the effect of the collision on passengers. There has been proposed a construction of a railroad vehicle in which the collision energy absorbing apparatus is provided in a forefront part of a forefront vehicle and absorbs the collision energy generated upon collision by the deformation of the apparatus (Japanese Patent Laid-Open Publication No. 7-186951). This impact energy absorbing apparatus (impact energy mitigation apparatus) is constituted by an element having a triangle in a plane perpendicular to the direction in which an impact force acts, a honeycomb panel and the like. The impact energy mitigation apparatus is arranged in a plurality of numbers parallel to the direction in which an impact force acts and along the direction in which an impact force acts.

The present applicant has already proposed a railway vehicle equipped with an impact mitigation mechanism that absorbs the impact upon collision by buckling deformation (Japanese Patent Publication No. 3725043). The impact mitigation mechanism has the sectional shape of a rectangular cylinder in which two parallel plate members are connected by a truss, is formed from what is called a double-skin hollow member, and has a prescribed length dimension in the axial direction.

Furthermore, the present applicant has already proposed an idea that in at least an underframe of the railway vehicle, members constituting both ends in the longitudinal direction of the car body are formed from a material which is soft compared to the material for members on the middle side in the longitudinal direction of the underframe. In this railroad vehicle, safety is aimed at by reducing and mitigating the effect of an impact on the passengers and the crew even in the event of a sudden vehicle collision and the like with scarcely any need to change the shape of the car body.

Also the present applicant paid attention to the fact that the rigidity of corner parts of the impact absorbing structure having the type of a rectangular cylinder is too high compared to other parts. And the present applicant improved the impact absorbing structure to a structure in which no truss is provided in the vicinity of edge lines of the corner parts having the shape of a rectangular cylinder. Thus, the present applicant has proposed an idea of reducing the rigidity of the corner parts of the impact absorbing structure compared to other parts, whereby the peak load upon collision is reduced and the impact absorbing properties are improved (Japanese Patent Laid-Open Publication No. 2005-75255).

The present applicant has also proposed an impact absorbing structure having the type of a rectangular cylinder as described above in which four plate members are joined by welding or the like (Japanese Patent Laid-Open Publication No. 2005-75256). In the impact absorbing structure, a plurality of reinforcing plate members are spaced longitudinally and attached by welding in an inner space having the shape of a rectangular cylinder. The impact absorbing structure absorbs impact by buckling. When the impact absorbing structure having the shape of a rectangular cylinder buckles and absorbs impact, the reinforcing plate members prevent the buckling followed by excessive deformation, whereby an improvement in the energy absorbing properties is aimed at.

Furthermore, the present applicant has also proposed an impact absorbing structure having a section in the shape of a rectangular cylinder in which four hollow sections of aluminum alloy are joined at parts that become corner parts by welding using the same additive or other means (Japanese Patent Laid-Open Publication No. 2005-75293). In each of the hollow sections, an outer plate and an inner plate are connected by a truss. Because the hollow sections and welds are formed from the same aluminum alloy, each part is uniformly compressed and deformed upon impact, whereby the energy absorbing properties is aimed at.

Moreover, by ensuring that by joining members by frictional agitation welding along the longitudinal direction of the car body at least in the underframe, the metallurgical structure of the area subjected to the frictional agitation treatment becomes fine and the absorbed energy value increases, the present applicant aims to improve the energy absorbing properties in welds that are considered to be weak against collision energy (Japanese Patent Publication No. 3725057).

In a railway vehicle, the inner space of the car body is limited and particularly in car end parts in the longitudinal direction of the car body, it is difficult to ensure a sufficient space in which a collision energy absorbing apparatus is to be installed, because equipment, such as a coupling device, is installed there. This tendency is remarkable, for example, in the case of a railway vehicle in which an opening and closing type coupler cover or the like is installed in a forefront part of a forefront vehicle. Also, in a case where in installing a collision energy absorbing energy apparatus in the car body, a slight impact acts to such an extent that the energy absorbing body itself is partially deformed, it is necessary to replace the whole collision energy absorbing apparatus and a rise in cost is feared.

Therefore, there is a problem to be solved in the point that in the car end part of a railway vehicle equipped with a collision energy absorbing apparatus, a structure is provided which has a prescribed static strength for a static load of such an extent that causes slight deformation in the energy absorbing body and furthermore, the railway vehicle has a structure having energy absorption performance capable of absorbing impact energy effectively on the occasion of the original collision.

The object of the present invention is to provide a railway vehicle equipped with a collision energy absorbing apparatus capable of avoiding the deformation of an energy absorbing body, which constitutes the collision energy absorbing apparatus, when a slight static load acts to such an extent that causes the deformation of the energy absorbing body, by adding a structure having a prescribed static strength. Also, the object of the present invention is to provide a railway vehicle equipped with a collision impact absorbing apparatus whose energy absorbing body can absorb the impact energy on the occasion of the original expected collision and which can further mitigate loads on the car body proper, passengers and the like.

### SUMMARY OF THE INVENTION

In order to solve the above-described problem, the railway vehicle according to the present invention is equipped with a collision energy absorbing apparatus constituted by an energy absorbing body that absorbs the impact energy by being crushed upon collision and also a cover that covers the energy absorbing body and is broken upon collision.

According to this railway vehicle, the cover that covers the energy absorbing body has a prescribed static strength and, therefore, when a slight impact reaches the energy absorbing body in a condition before the collision energy absorbing apparatus is installed in the car body or during the installation work thereof in the car body, the cover fulfills the role of withstanding the impact. Also, when a slight collision occurs in the railway vehicle, the cover fulfills the role of withstanding a prescribed static load. When a railway vehicle, in whose car body the collision energy absorbing apparatus is installed, collides with an obstacle or the like, before the absorption of the collision energy by the deformation of the energy absorbing body, part of the collision energy is absorbed by being used in the breakage of the cover. Also, by housing the energy absorbing body along with its cover in the limited inner space of the bar body, it is possible to dispose the collision energy absorbing apparatus safely in the interior of the car body and the like.

In the railway vehicle constructed as described above, a cover is added to the energy absorbing body that constitutes the collision energy absorbing apparatus as a structure having a prescribed static strength. Because the cover itself has static strength, the cover fulfills the role of withstanding a prescribed static load when a slight impact reaches the energy absorbing body or when a slight collision occurs in the car body. Therefore, it is possible to protect the energy absorbing body from a static load due to a slight collision and it is also possible to cope with a breakage of the cover, if it occurs, by replacing the cover alone unless the energy absorbing body is crushed. Also, in the case of an impact which is such that deformation extends to the energy absorbing body, part of the collision energy is used by the breakage of the cover before the deformation of the energy absorbing body. Therefore, the peal load of collision and crush is reduced and it is possible to mitigate loads on the car body proper, passengers and the like.

### BRIEF DESCRIPTION OF THE DRAWINGS

FIG. 1 is a bottom sectional view that shows part of a forefront vehicle equipped with a collision energy absorbing apparatus according to the present invention, the front right half of the collision energy absorbing apparatus cut in the center height position of the apparatus being viewed from the bottom side of the vehicle;

FIG. 2 is a longitudinal sectional view that shows part of the forefront vehicle shown in FIG. 1 in section;

FIG. 3 is a side view of the collision energy absorbing apparatus shown in FIG. 1;

FIG. 4 is a view of an energy absorbing body and a cover shown in FIG. 3, taken in the direction of the arrows A-A;

FIG. 5 is a view of an energy absorbing body and a cover shown in FIG. 3, taken in the direction of the arrows B-B;

FIG. 6 is a view of an energy absorbing body and a cover shown in FIG. 3, taken in the direction of the arrows C-C;

FIG. 7 is a view of an energy absorbing body and a cover shown in FIG. 3, taken in the direction of the arrows D-D;

FIG. 8 is a diagram that shows a broken condition of a cover used in the energy absorbing body shown in FIG. 3;

FIG. 9 is a front view that shows an example of an energy absorbing body;

FIG. 10 is a diagram that shows a crushed condition of the energy absorbing body shown in FIG. 9; and

FIG. 11 is a graph that shows an example of the distribution of a peak load.

### DETAILED DESCRIPTION OF THE PREFERRED EMBODIMENTS

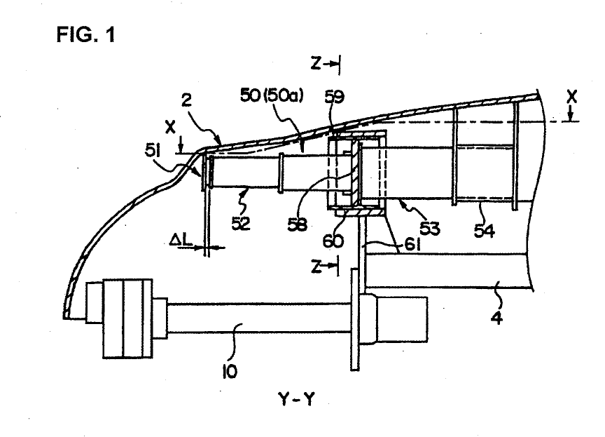

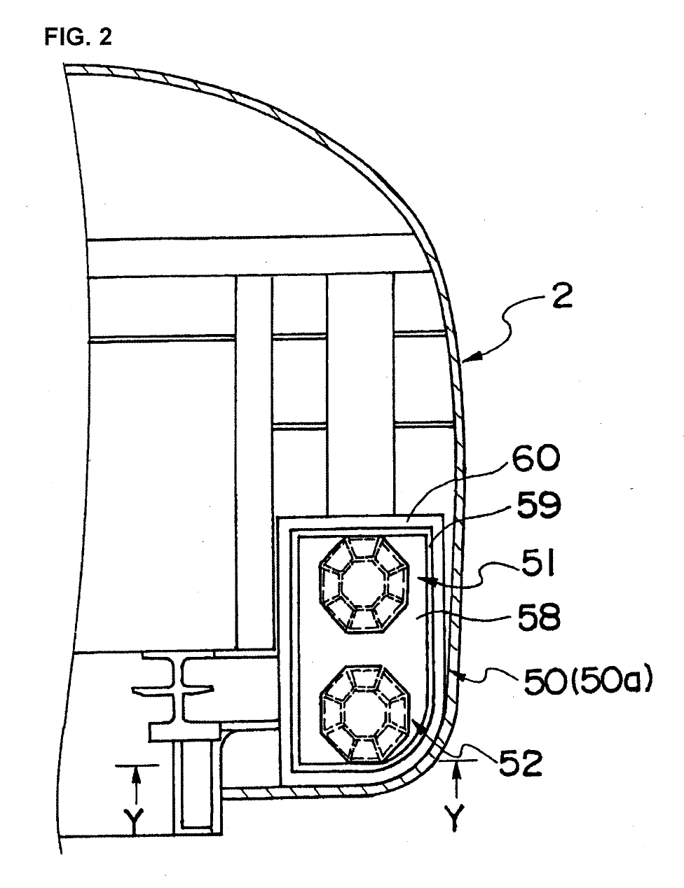

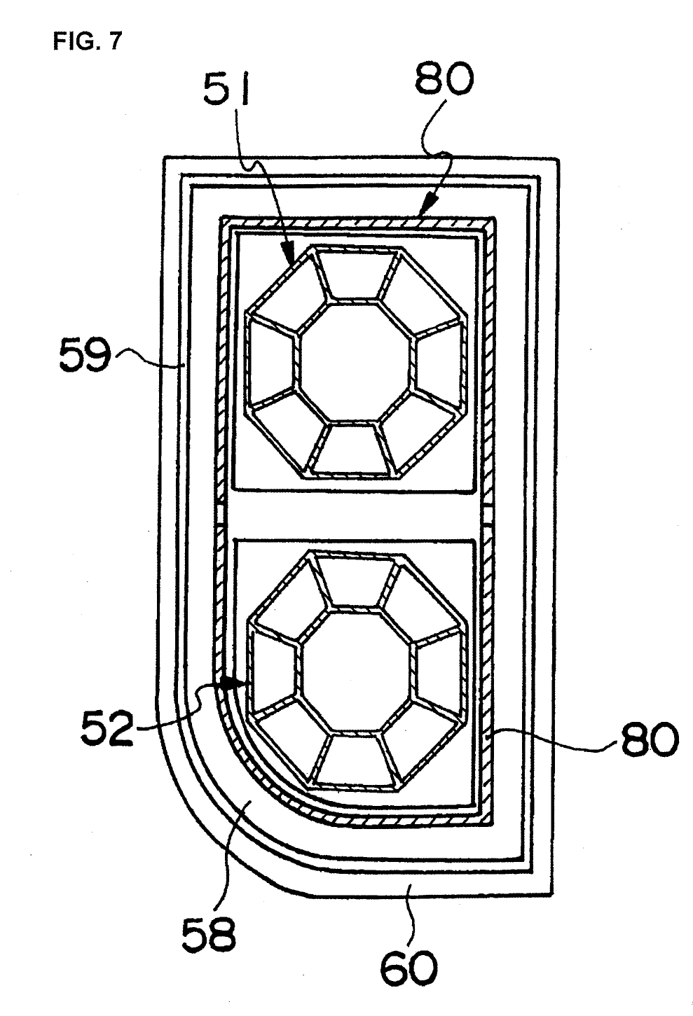

Next, on the basis of FIGS. 1 to 9, a description will be given of an embodiment which is applied to a car end part, i.e., a forefront part of a forefront vehicle, which is a railway vehicle equipped with a collision energy absorbing apparatus of the present invention. In a forefront vehicle of the embodiment shown in the figure, the profile of a forefront part 2 thereof is formed so as to provide a convex curved surface forward. As shown in FIGS. 1 and 2, a collision energy absorbing apparatus 50 that absorbs part of the collision energy generated upon collision against an obstacle and the like is arranged in the forefront part 2.

The collision energy absorbing apparatus 50 is installed on each of both sides in the width direction of the forefront vehicle. In FIGS. 1 and 2, only one side in the width direction of the car body is shown. That is, a collision energy absorbing apparatus 50a and a collision energy absorbing apparatus 50b that have the same construction are symmetrically installed on both sides in the width direction of the car body. The reference numeral 10 denotes a coupler that is installed in the forefront part to couple a vehicle and another vehicle together. The coupler 10 is installed, with the longitudinal direction thereof set along the longitudinal direction of the car body, in the center position of the width direction of the car body. The collision energy absorbing apparatuses 50a, 50b are attached to the car end part in the longitudinal direction of the underframe 4.

The collision energy absorbing apparatuses 50a, 50b are constructed by arranging a plurality of energy absorbing bodies in vertical alignment. That is, in each of the collision energy absorbing apparatuses 50a, 50b, a first energy absorbing body 51 and a second energy absorbing body 52, which absorb the collision energy by being crushed upon collision of an obstacle and the like from the car end side, are arranged in two layers in vertical alignment. The first and second energy absorbing bodies 51, 52 are attached to a common support plate 58 in positions near the middle of the car body in the longitudinal direction of the car body. One common third energy absorbing body 53 is connected to a surface near the middle of the car body in the longitudinal direction of the car body, i.e., to a surface on the rear side of the support plate 58. The third energy absorbing body 53 is connected to the underframe 4 via a frame 54 in an end part near the middle of the car body, i.e., in the rear end part. Each of the collision energy absorbing apparatuses 50a, 50b is constituted by the first and second energy absorbing bodies 51, 52, the support plate 58, and the third energy absorbing body 53.

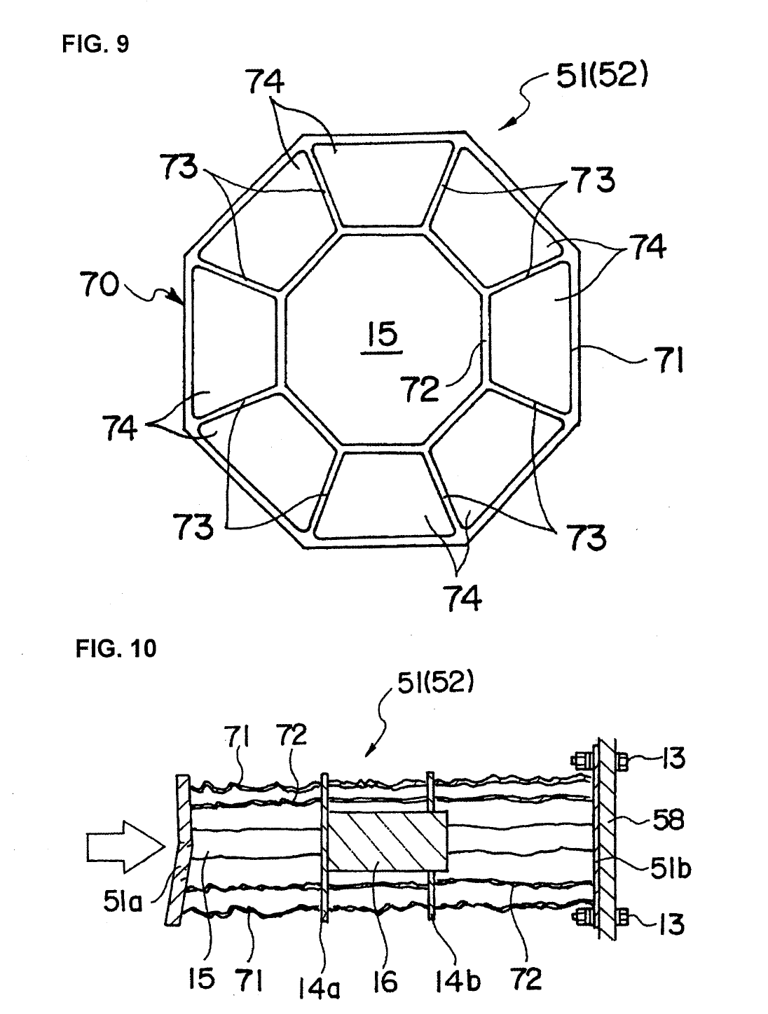

As shown in FIG. 9, each of the first to third energy absorbing bodies 51 to 53, which constitute the collision energy absorbing apparatuses 50a, 50b, is constituted by a cylindrical body 70 that has an octagonal section and a hollow structure inside. The cylindrical bodies 70 are arranged in alignment in a direction in which the axis lines thereof are substantially parallel to the longitudinal direction (fore-and-aft directions and travel directions) of the railway vehicle. This cylindrical body 70 is formed from units to provide an octagonal section as a whole, each unit consisting of an outer wall part 71, an inner wall part 72 and radial wall parts 73 that connect corner parts corresponding to the wall parts 71, 72 on both sides and extend radially, the wall parts having different outside dimensions. The outer wall part 71 and the inner wall part 72 have similar figures in sectional shape. On the inner side of the inner wall part 72 that forms a cylindrical body, there is formed a space 15 that extends axially along the axial direction. In an annular gap between the outer wall part 71 and the inner wall part 72, there is formed a space 74 partitioned by the plurality of radial wall parts 73, 73. The energy absorbing bodies 51 to 53 have the same sectional shape in their axis line directions. Therefore, the energy absorbing bodies 51 to 53 can be manufactured by using extruded sections of aluminum alloy as the material. The first energy absorbing body 51, the second energy absorbing body 52 and the third energy absorbing body 53 are constructed in such a manner that the nearer to the middle of the car body in the longitudinal direction of the car body, i.e., to the rear part they are installed, the larger the sectional area of these energy absorbing bodies will be.

The support plate 58 is formed to provide a peripheral edge of a rough quadrangle, and a guide cylinder 59 with a roughly quadrangular cylindrical shape is attached to the peripheral edge. The guide cylinder 59 is fitted into the guide cylinder plate 60 so that a peripheral surface 59a thereof is slidable on an inner surface 60a of the guide cylinder plate 60. The guide cylinder plate 60 is attached to the car body. Therefore, when the railway vehicle collides against an obstacle and the like, first, the first energy absorbing body 51 and the second energy absorbing body 52 are crushed, and subsequently the third energy absorbing body 53 is crushed. In connection with the crush of the third energy absorbing body 53, the guide cylinder 59 along with the support plate 58 moves toward the middle of the car body in the longitudinal direction of the car body, i.e., rearwards while being guided by the guide cylinder plate 60. Because the first and second energy absorbing bodies 51, 52 are guided by the inner surface 60a of the guide cylinder plate 60 in an intermediate position of the collision energy absorbing apparatus, it is possible for the first and second energy absorbing bodies 51, 52 to exhibit the collision energy absorbing action along the full length without being buckled in the intermediate position. The guide cylinder plate 60 is installed on the car end side of the underframe 4 in the longitudinal direction of the car body. A motorman's cab is constructed near the middle of the car body compared to the guide cylinder plate 60, i.e., at the rear. A flying object protection plate 61 is installed in the car end position of the motorman's cab and the front side of the motorman's cab is covered with the flying object protection plate 61. The guide cylinder plate 60 is installed in an opening formed in the flying object protection plate 61.

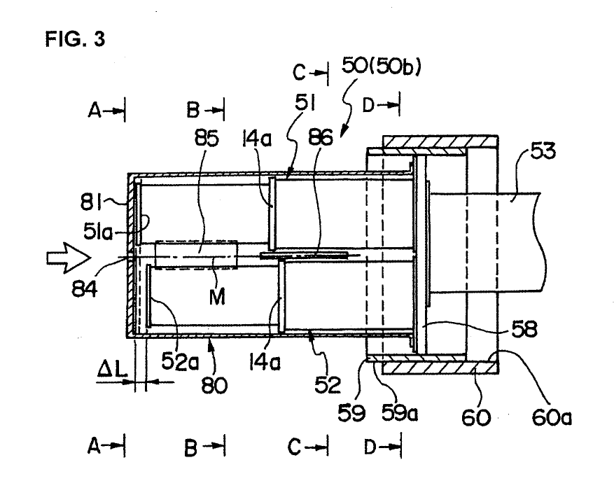

As shown in FIG. 3, the leading end positions in the collision direction of the first and second energy absorbing bodies 51, 52 are shifted to a plurality of positions in the longitudinal direction of the car body. That is, the first and second energy absorbing bodies 51, 52 have slightly different lengths in the collision direction, and in the condition supported by the support plate 58, the leading end position of the first energy absorbing body 51 lies on the car end side slightly (ΔL, for example, on the order of 100 mm) compared to the leading end position of the second energy absorbing body 52, i.e., at the front. Due to the difference in the leading end position of these energy absorbing bodies, in the event of a collision the first energy absorbing body 51 begins to be crushed earlier than the second energy absorbing body 52. For example, an example of a concrete crushed condition of the energy absorbing body 51 (52) of FIG. 9 is shown in FIG. 10. The crush of the first and second energy absorbing bodies 51, 52 proceeds, while the cylindrical bodies that constitute each energy absorbing body repeating microbuckling in their axis directions, with their axis lines kept, and being crushed virtually in straight lines. At this time, the first and second energy absorbing bodies 51, 52 absorb the collision energy while the whole being deformed like an accordion hose, and not undergoing total buckling like elbowed bending. This deformation of the first and second energy absorbing bodies 51, 52 is called crush. The first and second energy absorbing bodies 51, 52 after crush obtain, for example, a bellows structure in a shrunk condition. The reference numerals 51a, 51b denote end plates of the energy absorbing body 51 (52), the reference numerals 14a, 14b denote joint plates, and the reference numeral 16 denotes a buckling preventing member. The energy absorbing body 51 (52) shown in FIGS. 9 and 10 has a construction different from that of the energy absorbing body shown in FIG. 3, and is of a construction provided with the two joint plates 14a, 14b. The buckling preventing member 16 is fixed to the joint plate 14a and disposed so as to pierce through an opening of the joint plate 14b. This buckling preventing member 16 fulfills the role of preventing the total buckling of the energy absorbing body 51 (52).

That is, the energy absorbing body 51 (52) is partitioned by the joint plates 14a, 14b in the longitudinal direction. The buckling preventing plate 16 is fixed to the joint plate 14a, and the trailing end of the buckling preventing plate 16 pierces through the joint plate 14b. When the distance from the joint plate 14a to the joint plate 14b in the energy absorbing body 51 (52) shrinks due to crush, the buckling preventing member 16 pierces through the joint plate 14b. Because of this, the energy absorbing body 51 (52) is crushed like an accordion hose without undergoing total buckling. For the energy absorbing body 51 and the energy absorbing body 52, also the longitudinal position of one of the joint plates 14a protrudes from the other as with the positions of the end plates 51a, 52a.

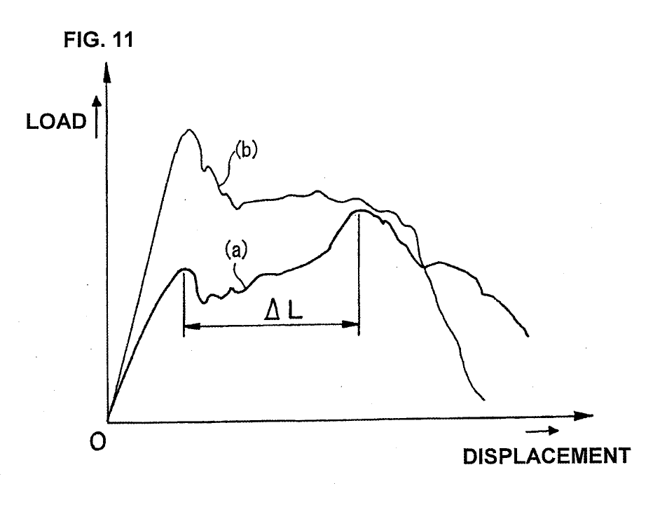

In the two energy absorbing bodies 51, 52 having different lengths, a peak load due to collision is distributed by a slight difference in the crush start period. Therefore, the crush peak loads of the energy absorbing members 51, 52 are reduced and it is possible to mitigate the impact on the car body, passengers and the like. How a peak load is distributed is shown in FIG. 11 as an example. In the case of an arrangement in which the energy absorbing bodies are disposed with their leading ends aligned with each other, as indicated by a thin line in FIG. 11, the crush start begins simultaneously, with the result that a very high peak load occurs at the beginning of the crush start. However, because of the difference in the period of crush start corresponding to the shift ΔL of the position of the energy absorbing bodies 51, 52 as in this embodiment, there occurs a shift in the period of a peak load as indicated by a thick line in FIG. 11, with the result that it is possible to suppress the peak load.

The collision energy absorbing apparatus 50 shown in FIGS. 1 to 3 is provided with a cover 80. The cover 80 has a size large enough to be able to cover the energy absorbing bodies 51, 52 that constitute the collision energy absorbing apparatus 50. The cover 80 is formed in the shape of a box having a roughly rectangular shape as a whole. The cover 80 has the shape of a cylindrical container, with one end thereof closed in the longitudinal direction and the other end opened. The cover 80 that covers the two energy absorbing bodies 51, 52 is constructed as a single member. Incidentally, as shown in FIG. 2, when the shape is such that the car body profile forms a large curved surface in the forefront part 2 of the car body, the cover 80 is constructed so that part of the cover 80 is in a curved shape so as to fit the curved surface of the car body profile. The cover 80 is placed from the car end side of the energy absorbing bodies 51, 52 and attached to the support plate 58. And the cover 80 is supported in a cantilevered manner on an end part near the middle of the car body in the longitudinal direction of the car body of the energy absorbing bodies 51, 52, i.e., on the base end side. Although in this cantilevered support of the cover 80, the cover 80 is supported by the energy absorbing apparatus as with the support plate 58, the cover 80 may be attached to members on the side of the railway vehicle, such as the guide cylinder plate 60. The cover 80 can cover the whole of the energy absorbing bodies 51, 52 which are arranged in vertical alignment by one piece, and is attached to the support plate 58 on the opening side. The cover 80 combines a prescribed static strength and the collision energy absorption performance that complements the impact energy absorption function of the energy absorbing bodies 51, 52. Thanks to its static strength, the cover 80 prevents irregularities, such as the breakage of cylindrical bodies of aluminum alloy, i.e., the energy absorbing bodies 51, 52 in each of the stages of transportation, storage, assembling and the like of the collision energy absorbing apparatus 50. Furthermore, even after the mounting of the collision energy absorbing apparatus 50 on the car body, in the event of the occurrence of a slight collision, it is also possible that the impact is absorbed by the cover 80. In such cases, the cover 80 fulfills the function of absorbing collision energy due to a slight collision by being broken and deformed. In the case of a slight collision, no deformation occurs in the energy absorbing bodies 51, 52 because of the deformation of the cover 80. When the collision energy is absorbed only by the deformation of the cover 80, the action of replacement of the cover 80 alone is sufficient and, therefore, it is unnecessary to carry out a large-scale repair or to replace the collision energy absorbing apparatus 50 itself. There may sometimes be cases where in the event of a collision, the collision energy cannot be absorbed only by the deformation of the cover 80 and the impact reaches the energy absorbing bodies 51, 52. In the case of such a large collision, an obstacle or the like collides against the cover 80 immediately before collision against the energy absorbing bodies 51, 52, and the cover 80 is divided into an upper portion and a lower portion along a breakage-intended path M. Because the breakage of the cover 80 occurs a little before the occurrence of a load peak due to the crush of the energy absorbing bodies 51, 52, it is possible to suppress the crush peak load of the energy absorbing bodies 51, 52 to a greater extent.

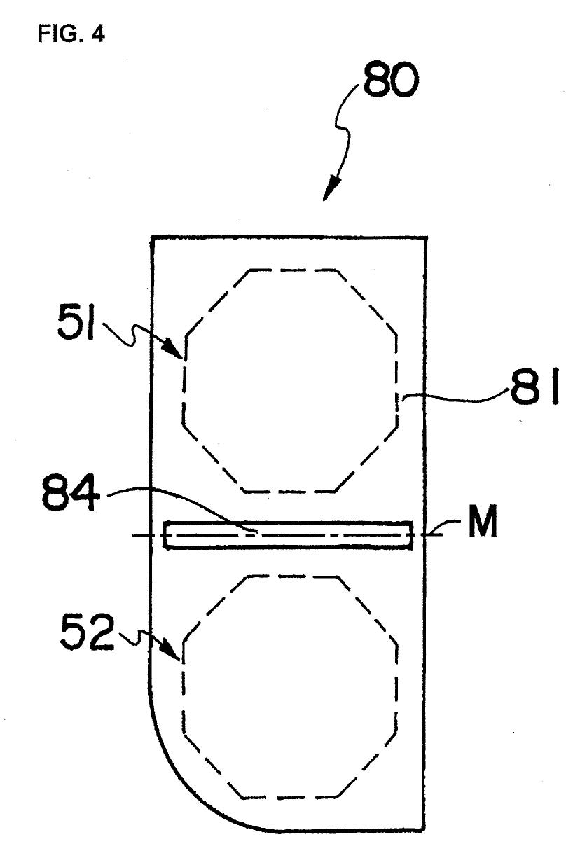

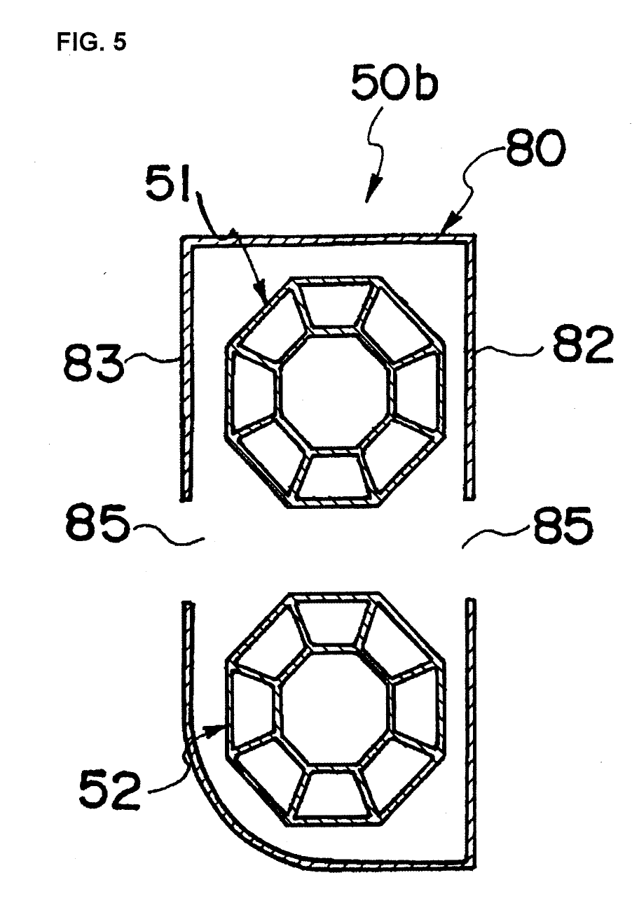

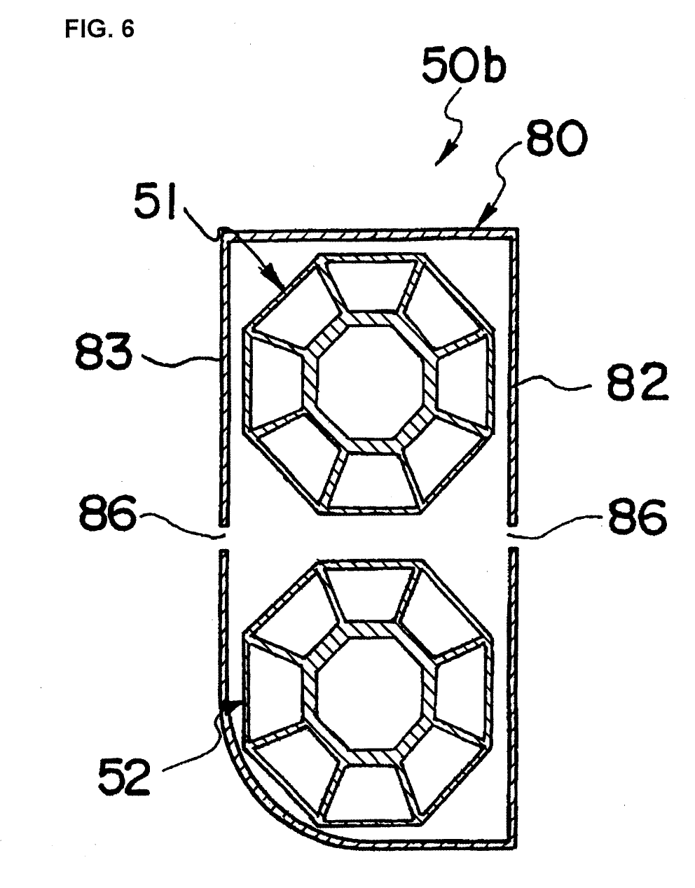

For an embodiment of the cover 80, the construction of the cover 80 will be described on the basis of FIGS. 3 to 7. The cover 80 has the shape of a cylindrical container that forms a roughly rectangular parallelepiped and the part to be attached to the support plate 58 forms an opened pentahedron. The cover 80 is constituted by a front end part 81 positioned on the car end side, side wall parts 82, 83 positioned on both sides of the width direction of the car body, and a bottom wall part and a top wall part that are vertically positioned. The front end part 81 is constituted by a substantially flat plate member. In the front end part 81, a first slit 84 is formed in a vertically middle zone along a substantially horizontal direction. As shown in FIG. 4, the installed position of this first slit 84 virtually corresponds to the space part between the first energy absorbing body 51 and the second energy absorbing body 52 as shown in FIG. 4. Furthermore, as shown in FIG. 3, FIG. 5 and FIG. 6, a plurality of second slits 85, 86 are formed in the vertically middle zone of the side wall parts 82, 83 in order to facilitate the vertical breakage of the side wall parts themselves. The second slits 85, 86 are formed in the longitudinal direction of the car body, i.e., along the axis line direction of the energy absorbing bodies 51, 52. The second slits 85, 85 on the car end side and the second slits 86, 86 on the middle side of the car body in the longitudinal direction of the car body are formed in the side wall parts 82, 83. The second slit 85 on the car end side is formed so as to provide a wider gap than the second slit 86, and these slits are formed discontinuously along the longitudinal direction of the car body. The first slit 84 and the second slits 85, 86 are formed in a substantially intermediate position in the vertical direction of the cover 80, and this position is the breakage-intended path M shown in FIG. 3. Incidentally, although an example in which the second slits 85, 86 are formed discontinuously was shown, it is obvious that the second slits 85, 86 may be formed continuously. The distance of discontinuity is short. The first slit 84 and the second slits 85, 86 are formed in order to facilitate the vertical breakage of the cover 80 when an obstacle or the like collides against the cover 80 from the car end side.

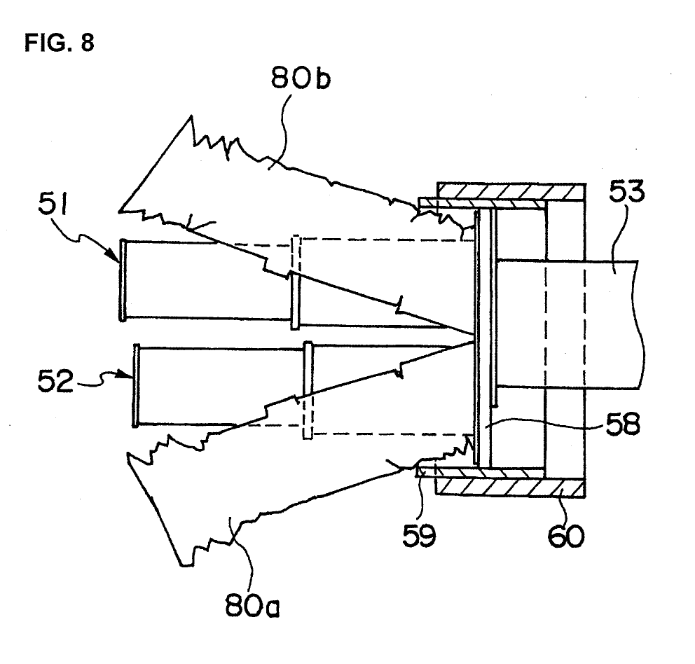

When the railway vehicle collides against an obstacle, a large impact load acts on the car end side, i.e., the front end part 81 of the cover 80. The condition in which the cover 80 is broken in this case is shown in FIG. 8. Because in the cover 80, the parts of the first slit 84 and the second slits 85, 86 have lower strength than other parts, they become parts that are easily broken, and they are broken along the breakage-intended path M. For the cover 80, a condition in which the cover 80 is vertically divided into two portions as a broken piece 80a and a broken piece 80b is the most ideal condition. FIG. 8 schematically shows how the cover 80 is broken by being divided into two parts in the vertical direction intersecting the collision direction (the direction indicated by the arrow in FIG. 3 (the direction substantially along the longitudinal direction of the car body)). The broken pieces 80a, 80b are deformed so as to open vertically. Therefore, because there are relatively few members that provide obstacles in the vertical direction of the cover 80, the behavior of the broken pieces 80a, 80b is allowed in the limited interior of the car body. On the occasion of this breakage, the cover 80 can complement the absorption function of the energy absorbing bodies 51, 52 by absorbing part of the collision energy. And after its opening, the cover 80 does not prevent the energy absorption function of the energy absorbing bodies 51, 52. Incidentally, it is also conceivable to adopt a construction in which further slits are provided in positions of the bottom wall part and top wall part near the middle of the car body in order to promote the deformation of the cover 80, thereby dividing the cover 80 into two portions in the vertical direction. Incidentally, the rigidity of the cover 80 is lower than that of the energy absorbing bodies 51, 52 and hence the cover 80 is deformed by a slight impact. Therefore, even if the deformation of the cover 80 is such that the cover 80 is not divided into two portions in the vertical direction, the cover 80 does not exert an adverse effect on the energy absorption function of the energy absorbing bodies 51, 52.

Although the above-described embodiment of the collision energy absorbing apparatus provided with a cover is applied to the forefront part of the railway vehicle, the present invention is not limited to this. Even when the collision energy absorbing apparatus is arranged in car end portions of intermediate vehicles connected to the forefront vehicle in a train of railway vehicles, the collision energy absorbing apparatus exhibits similar operations and effects. Furthermore, it is needless to say that the present invention can be applied to a collision energy absorbing apparatus containing one energy absorbing body. A train of vehicles is constituted by forefront cars at the front and the tail and a required number of intermediate cars. For example, when the forefront vehicle or the vehicle at the tail collides against an obstacle or other vehicles, collision occurs successively not only between the intermediate vehicles adjacent to the forefront vehicle or the vehicle at the tail, but also between the end parts of adjacent intermediate vehicles. By using the collision energy absorbing apparatus of the present invention, particularly to match the height of underframes of high strength in the end part of the forefront vehicle or the vehicle at the tail and in each car end part of the intermediate vehicles, it is possible to effectively absorb an impact by use of the collision energy absorption apparatus even when a collision occurs in any place of the train.

What is claimed is:

1. A railway vehicle equipped with a collision energy absorbing apparatus including an energy absorbing body that absorbs collision energy by being crushed upon collision, wherein the railroad apparatus has a cover that covers the energy absorbing body, is supported by the railway vehicle in a cantilevered manner toward the front of the collision, and becomes broken on the occasion of the collision.

2. The railway vehicle according to claim 1, wherein the energy absorbing body is arranged in vertical alignment in a plurality of numbers and the cover is a single cover that covers the whole of the energy absorbing bodies arranged in alignment.

3. The railway vehicle according to claim 1, wherein the cover is provided with a breakage-intended path which is intended, in the case of a collision, to break the cover in a direction intersecting the collision direction, and a slit to facilitate breakage is formed on the breakage-intended path.

4. The railway vehicle according to claim 1, wherein
the energy absorbing body is arranged in vertical alignment in a plurality of numbers,
the cover is a single cover that covers the whole of the energy absorbing bodies arranged in alignment,
the cover is provided with a breakage-intended path which is intended, in the case of a collision, to break the cover in a direction intersecting the collision direction,
a slit to facilitate breakage is formed on the breakage-intended path, and
the breakage-intended path is provided in a vertical middle zone that divides the cover into two parts of upper and lower portions.

5. The railway vehicle according to claim 1, wherein
the energy absorbing body is arranged in vertical alignment in a plurality of numbers,
the cover is a single cover that covers the whole of the energy absorbing bodies arranged in alignment,
the cover is provided with a breakage-intended path which is intended, in the case of a collision, to break the cover in a direction intersecting the collision direction,
a slit to facilitate breakage is formed on the breakage-intended path,
the breakage-intended path is provided in a vertical middle zone that divides the cover into two parts of upper and lower portions, and
the slit has a first slit formed in a front end part of the cover and a second slit formed in a side wall part of the cover.

6. The railway vehicle according to claim 1, wherein
the energy absorbing body is arranged in vertical alignment in a plurality of numbers,
the cover is a single cover that covers the whole of the energy absorbing bodies arranged in alignment,
the cover is provided with a breakage-intended path which is intended, in the case of a collision, to break
the cover in a direction intersecting the collision direction,
a slit to facilitate breakage is formed on the breakage-intended path
the breakage-intended path is provided in a vertical middle zone that divides the cover into two parts of upper and lower portions,
the slit has a first slit formed in a front end part of the cover and a second slit formed in a side wall part of the cover, and
the second slit is formed continuously or discontinuously, the width of the second slit being wide at the front of the collision.

7. A collision energy absorbing apparatus provided with an energy absorbing body that absorbs collision energy by being crushed upon collision, wherein the collision energy absorbing apparatus has a cover that covers the energy absorbing body, is supported in a cantilevered manner toward the front of the collision, and becomes broken on the occasion of the collision.
